(19) United States
(12) Patent Application Publication
(10) Pub. No.: US 2025/0165948 A1
(43) Pub. Date: May 22, 2025

(54) MERCHANDISE CHECKOUT SYSTEM, MERCHANDISE REGISTRATION DEVICE, AND MERCHANDISE REGISTRATION METHOD

(71) Applicant: TOSHIBA TEC KABUSHIKI KAISHA, Tokyo (JP)

(72) Inventor: Yoshitaka Kuniya, Mishima Shizuoka (JP)

(21) Appl. No.: 18/733,906

(22) Filed: Jun. 5, 2024

(30) Foreign Application Priority Data
Nov. 21, 2023 (JP) 2023-197089

(51) Int. Cl. G06Q 20/20; G06Q 20/18; G06Q 20/32

(52) U.S. Cl. CPC G06Q 20/208; G06Q 20/18; G06Q 20/327

(57) ABSTRACT

A merchandise checkout system includes a checkout medium, a registration unit, a checkout unit, and a reporting unit. The checkout medium includes a built-in wireless tag. The registration unit registers a merchandise item in one transaction and dispenses the checkout medium with payment information for settlement for the registered merchandise item in the one transaction written in the wireless tag. The checkout unit reads the payment information from the wireless tag in the checkout medium, performs settlement for the registered merchandise item in the one transaction, and rewrites the payment information to represent a state where there is no unpaid amount if the settlement is complete. The reporting unit gives a report if the payment information in the wireless tag represents a state where there is an unpaid amount when the checkout medium passes therethrough.

### CROSS-REFERENCE TO RELATED APPLICATION

This application is based upon and claims the benefit of priority from Japanese Patent Application No. 2023-197089, filed on Nov. 21, 2023, the entire contents of which are incorporated herein by reference.

### FIELD

Embodiments described herein relate generally to a merchandise checkout system, a merchandise registration device, and a merchandise registration method.

### BACKGROUND

According to the related art, a checkout system in which store staff carries out a registration task to register merchandise information of a merchandise item, a service or the like with a registration device and in which a shopper carries out checkout processing with a checkout device (hereinafter referred to as a semi-self-service-type checkout system) is known. In the semi-self-service-type checkout system, the shopper carries out checkout processing.

In such a semi-self-service-type checkout system, a plurality of checkout devices may be connected to one registration device. However, in a circumstance where store staff on the registration machine side designates which checkout machine to use to carry out checkout processing, that is, the destination of transaction data about one transaction, there is a risk of congestion on the checkout device side, such as in a case where a customer is taking a long time to carry out a checkout with the checkout machine. Also, it may be difficult for the shopper (customer) to grasp which checkout device to use to carry out checkout processing, such as in a case where it is difficult to find the checkout device designated by the store staff. In view of such circumstances, there is room for improvement in the efficiency of transaction in the semi-self-service-type checkout system.

### DESCRIPTION OF THE DRAWINGS

FIG. 1 is a block diagram showing an example of the configuration of a merchandise checkout system according to an embodiment.

FIG. 2 is a block diagram showing an example of the configuration of a store server.

FIG. 3 is a block diagram showing an example of the configuration of a registration machine.

FIG. 4 is a block diagram showing an example of the configuration of a checkout machine.

FIG. 5 is a block diagram showing an example of the configuration of an exit gate.

FIG. 6 is a flowchart showing an example of the flow of one transaction in the merchandise checkout system.

FIG. 7 is a sequence chart showing an example of the flow of processing for one transaction executed in the merchandise checkout system.

### DETAILED DESCRIPTION

An embodiment described herein is to improve the efficiency of transaction in the semi-self-service-type checkout system.

In general, according to one embodiment, a merchandise checkout system includes a checkout medium, a registration unit, a checkout unit, and a reporting unit. The checkout medium includes a built-in wireless tag. The registration unit registers a merchandise item in one transaction and dispenses the checkout medium where payment information for settlement for the merchandise item in the one transaction that is registered is written in the wireless tag. The checkout unit reads the payment information from the wireless tag in the checkout medium, carries out settlement for the merchandise item in the one transaction that is registered, and rewrites the payment information to represent a state where there is no unpaid amount if the settlement is complete. The reporting unit gives a report if the payment information in the wireless tag represents a state where there is an unpaid amount when the checkout medium passes therethrough.

A merchandise checkout system, a merchandise registration device, a checkout device, a gate device, a program, and a recording medium with this program recorded therein (computer program product) according to an embodiment will now be described with reference to the drawings.

The embodiment described below is one embodiment of a merchandise checkout system, a merchandise registration device, a checkout device, a gate device, a program, and a recording medium according to the present disclosure and does not limit the configurations, specifications, and the like thereof. The embodiment described below is an example of application to a POS (point of sales) system introduced in a store such as a supermarket.

Specifically, the merchandise checkout system according to the embodiment is a system configured to perform transaction processing at a store where a semi-self-service-type checkout system is introduced, such as a supermarket.

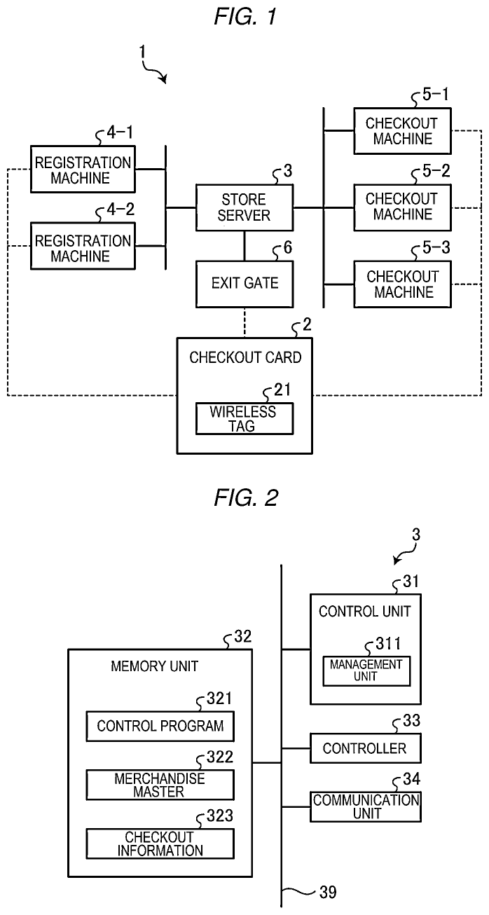

FIG. 1 is a block diagram showing an example of the configuration of a merchandise checkout system 1 according to the embodiment. The merchandise checkout system 1 includes a checkout card 2, a store server 3, a registration machine 4, a checkout machine 5, and an exit gate 6, as shown in FIG. 1.

In the merchandise checkout system 1, the store server 3 is communicably connected to each of the registration machine 4, the checkout machine 5, and the exit gate 6 via any communication network. As the communication network between these elements, one or a suitable combination of the internet, a VPN (virtual private network), a LAN (local area network), a public communication network, a mobile communication network, and the like, can be used.

In the merchandise checkout system 1, each of the store server 3, the registration machine 4, the checkout machine 5, and the exit gate 6 is configured to be wirelessly communicable with the checkout card 2, for example, using short-range wireless communication. The wireless communication may be via the internet, a VPN, a LAN, a public communication network, a mobile communication network, or the like.

The checkout card 2 is a checkout medium with a built-in wireless tag 21 such as an RFID (radio frequency identification) tag, as shown in FIG. 1. The wireless tag 21 holds (stores) payment information, described later, in such a way as to be readable from outside, for example, using short-range wireless communication. In the merchandise checkout system 1, at least a greater number of checkout cards 2 than the number of checkout machines 5 can be prepared. Preferably, the number of checkout cards 2 is greater than the total of the number of transactions in which merchandise registration is in progress at the store and the number of transactions in which merchandise registration is already done and the customer is yet to exit the store.

In this embodiment, for example, the checkout medium formed as a flat plate-like checkout card 2 is used as an example. However, this is not limiting. In an example, the checkout medium may be formed in a shape that can be easily carried by the customer like a keychain or a neck strap. In an example, the checkout medium may be formed in a shape that can be attached to a shopping basket or a shopping cart. In an example, the checkout medium may be a shopping basket with a built-in wireless tag 21. In an example, the checkout medium may be a shopping cart with a built-in wireless tag 21.

Preferably, the checkout medium is configured in such a way that it looks strange if the customer still holding the checkout medium exits the store. For example, preferably, the color and shape of the checkout medium may be defined in such a way that store staff, security staff, or monitoring staff can easily see the checkout medium or that the customer can be easily aware of himself or herself holding the checkout medium.

The store server 3 is at least one server device installed in, for example, the back office of the store or the like In an example, the store server 3 is installed and operated by a manager who manages the store where the store server 3 is installed. The store server 3 is not limited to being installed in the store but may be configured as a cloud server installed on a cloud. The store server 3 according to the embodiment is an example of a management unit.

FIG. 2 is a block diagram showing an example of the configuration of the store server 3 shown in FIG. 1. The store server 3 has a control unit 31, a memory unit 32, a controller 33, and a communication unit 34 as shown in FIG. 2. The control unit 31, the memory unit 32, the controller 33, and the communication unit 34 are communicably connected, for example, via a bus 39.

The control unit 31 has, for example, a processor such as a CPU (central processing unit), and a memory such as a ROM (read-only memory) and a RAM (random-access memory), and is configured similarly to a general computer. For example, the control unit 31 is configured to load various programs stored in the memory such as the ROM or the memory unit 32 into the RAM of the memory, cause the processor to execute the various programs thus loaded, and thereby implement various functions of the store server 3 including a management unit 311.

The management unit 311 collects sales information from at least one registration machine 4 provided at the store. For example, the management unit 311 stores the sales information received from the registration machine 4 and manages the sales at the store, using the stored sales information.

The management unit 311 also acquires and stores checkout information 323 linked with identification information (checkout card number) of the checkout card 2 from at least one registration machine 4 provided at the store. That is, the management unit 311 acquires and stores payment information and an image of a face photograph of the customer each of which is linked with the checkout card number. If a camera that can capture an image of the face of the customer is provided outside the registration machine 4 in the store, for example, as in a case where the registration machine 4 is not provided with an image capture unit 48 or the like, the management unit 311 may acquire an image of a face photograph of the customer from the camera, link the image along with the payment information with the checkout card number of the checkout card 2 acquired from the corresponding registration machine 4, and store the image as the checkout information 323.

The management unit 311 changes the checkout information 323 to the effect that the checkout is complete, for example, in response to a notification of the completion of the settlement from the checkout machine 5 including the identification information (for example, the checkout card number) of the checkout card 2. Then, in view of privacy protection, the store server 3 discards the face image of the customer linked with the checkout card 2 defined to the effect that the checkout is complete.

As the processor of the control unit 31, another processor instead of or in addition to the CPU may be provided. As the another processor, various processors such as a GPU (graphics processing unit) and a DSP (digital signal processor), and a dedicated computing circuit implemented by an ASIC (application-specific integrated circuit) or an FPGA (field-programmable gate array) or the like can be used according to need.

As the memory of the control unit 31, a non-volatile recording medium such as an HDD (hard disk drive), an SSD (solid-state drive) or a flash memory can be used according to need, in addition to the ROM and the RAM.

The memory unit 32 is a memory device having a non-volatile recording medium such as an HDD, an SSD or a flash memory. The memory unit 32 stores various programs and various data related to operations of the store server 3, and a device driver for a device connected to the store server 3 via the controller 33, or the like.

In an example, the memory unit 32 stores a control program 321, a merchandise master 322, and the checkout information 323. For example, the control program 321 includes at least one program to implement each functional unit of the store server 3. For example, the merchandise master 322 stores merchandise information of each merchandise item in correlation with merchandise specifying information that specifies the merchandise item. The merchandise specifying information is, for example, a merchandise code indicating the merchandise item but may be any information that specifies the merchandise item and may be not the merchandise code. The checkout information 323 includes payment information about checkout on a per transaction basis, written on each checkout card 2 at each registration machine 4. The payment information about one transaction includes the merchandise information such as the merchandise code, the unit price, and the number of items, about each of at least one merchandise item the merchandise registration of which is already done, and the total amount to be paid. The checkout information 323 also includes an image of a face photograph of the customer on a per transaction basis. That is, the checkout information 323 about one transaction is information including the payment information and the face image each of which is linked with the checkout card number (identification information) of the checkout card 2.

The controller 33 is an input-output interface to connect a device to the store server 3.

The communication unit 34 is a communication interface to communicate with the outside of the store server 3. The communication unit 34 includes one of a communication circuit for wired communication and a communication circuit for wireless communication and connects to the foregoing communication network via the communication circuit.

The registration machine 4 is at least one sales data processing device (POS terminal or merchandise registration device) installed at the store. The registration machine 4 is configured to be able to execute, for example, at least registration processing of transaction processing related to one transaction for a merchandise item to be purchased at the store, that is, of registration processing and settlement processing for the merchandise item. The registration machine 4 according to the embodiment is an example of a registration unit.

The registration processing for a merchandise item is the processing of reading merchandise information (merchandise name, merchandise price, and the like) of a merchandise item specified by package recognition processing or the like, from the merchandise master, and registering the merchandise information. The settlement processing is the processing of displaying the total amount and the amount of tax of the merchandise item in one transaction the merchandise registration of which is already done, calculating and displaying the change, based on the deposit amount deposited by the customer, and dispensing a receipt on which the merchandise information and the settlement information (total amount, deposit amount, amount of change, and so on) are printed, or the like.

The registration machine 4 may be configured to be used by store staff to carry out operations related to the transaction processing or may be a semi-self-service-type in which the customer carries out a part of operations related to the settlement processing. The registration machine 4 may be integrated with the store server 3.

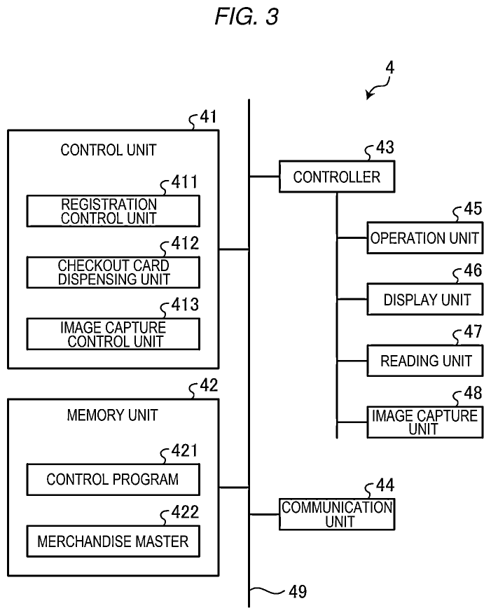

FIG. 3 is a block diagram showing an example of the configuration of the registration machine 4 shown in FIG. 1. In an example, the number of registration machines 4 is smaller than the number of checkout machines 5. FIG. 3 shows registration machines 4-1, 4-2 as the registration machines 4. The number of registration machines 4 may be one or may be three or more. The number of registration machines 4 need not necessarily be smaller than the number of checkout machines 5. The registration machine 4 has a control unit 41, a memory unit 42, a controller 43, a communication unit 44, an operation unit 45, a display unit 46, a reading unit 47, and an image capture unit 48, as shown in FIG. 3. The control unit 41, the memory unit 42, the controller 43, and the communication unit 44 are communicably connected, for example, via a bus 49. The operation unit 45, the display unit 46, the reading unit 47, and the image capture unit 48 are communicably connected to the controller 43.

The control unit 41 has, for example, a processor such as a CPU, and a memory such as a ROM and a RAM, and is configured similarly to a general computer. For example, the control unit 41 is configured to load various programs stored in the memory such as the ROM or the memory unit 42 into the RAM of the memory, cause the processor to execute the various programs thus loaded, and thereby implement various functions of the registration machine 4 including a registration control unit 411, a checkout card dispensing unit 412, and an image capture control unit 413.

The registration control unit 411 controls the reading unit 47 and thus acquires merchandise specifying information that specifies a reading target merchandise item. The registration control unit 411 performs registration processing to register the merchandise item, based on the merchandise specifying information of the merchandise item thus read. In the registration processing, the registration control unit 411 finalizes the payment information of the merchandise item in one transaction on a per transaction basis. The registration control unit 411 according to the embodiment is an example of the registration unit.

The checkout card dispensing unit 412 controls the reading unit 47, thus acquires the checkout card number (identification information) of the checkout card 2 (checkout medium) held over or inserted in the reading unit 47, for example, by store staff, and recognizes the checkout card 2. Also, the checkout card dispensing unit 412 controls the reading unit 47 and thus performs dispensing processing of the recognized checkout card 2. The dispensing processing of the checkout card 2 includes writing processing to write the payment information about one transaction finalized by the registration control unit 411 to the wireless tag 21 in the checkout card 2. That is, the checkout card dispensing unit 412 dispenses the checkout card 2 in which the payment information for the settlement of the registered merchandise item is written in the wireless tag 21. The checkout card dispensing unit 412 also links the payment information written on the checkout card 2 with the checkout card number thereof and transmits the payment information to the store server 3. The checkout card dispensing unit 412 according to the embodiment is an example of a dispensing unit.

The checkout card 2 is collected and recovered, for example, in a checkout card recovery (return) box provided on the store exit side of the exit gate 6, for example, after the customer performs the settlement processing with the checkout machine 5. Thus, the checkout card 2 may be used a plurality of times a day. Therefore, the checkout card dispensing unit 412 controls the reading unit 47 and thus checks whether payment information representing a state where there is an unpaid amount is recorded on the checkout card 2, before the writing processing to write the payment information. If the checkout card 2 is recovered in the state where there is an unpaid amount, that is, if payment information representing the state where there is an unpaid amount is recorded on the checkout card 2 before the payment information is written, the checkout card dispensing unit 412 reports the occurrence of a theft to store staff. This reporting may be performed, for example, via a screen display by the display unit 46. Also, an indicator lamp (warning lamp) may be provided separately at the registration machine 4 and may be switched on to perform the reporting. Also, a speaker may be separately provided at the registration machine 4 and may output a voice or a notification sound (warning sound) to perform the reporting.

The image capture control unit 413 controls the image capture unit 48, thus captures an image of the face of the customer in one transaction on a per transaction basis, and performs face image acquisition processing to acquire a face image. The image capture control unit 413 also links the acquired face image with the checkout card number related to the one transaction and transmits the face image to the store server 3. The image capture control unit 413 according to the embodiment is an example of an image capture unit.

As the processor of the control unit 41 according to the embodiment, various processors such as a GPU and a DSP, and a dedicated computing circuit implemented by an ASIC or an FPGA, or the like, can be used according to need, instead of or in addition to the CPU.

The memory unit 42 is a memory device having a non-volatile recording medium such as an HDD, an SSD or a flash memory. The memory unit 42 stores various programs and various data related to operations of the registration machine 4, and a device driver for a device connected to the registration machine 4 via the controller 43, or the like.

In an example, the memory unit 42 stores a control program 421 and a merchandise master 422. For example, the control program 421 includes at least one program to implement each functional unit of the registration machine 4. For example, the merchandise master 422 stores merchandise information of each merchandise item in correlation with merchandise specifying information that specifies the merchandise item. The merchandise specifying information is, for example, a merchandise code indicating the merchandise item but may be any information that specifies the merchandise item and may be not the merchandise code.

The controller 43 is an input-output interface to connect a device to the registration machine 4. In the example shown in FIG. 3, the operation unit 45, the display unit 46, the reading unit 47, and the image capture unit 48 are connected to the controller 43.

The communication unit 44 is a communication interface to communicate with the outside of the registration machine 4. The communication unit 44 includes one of a communication circuit for wired communication and a communication circuit for wireless communication and connects to the communication network via the communication circuit.

The operation unit 45 is an input interface that accepts an operation input from a user such as store staff. The operation unit 45 is, for example, a touch panel that is arranged on a display surface (screen) of the display unit 46 and that detects a touch operation by an operator and outputs a signal to the control unit 41. In an example, the operation unit 45 is configured to be able to accept an operation input from the operator to an operation screen displayed on the display unit 46. As the operation unit 45, not only the touch panel but also various input devices such as a keyboard, a switch, and a button can be provided according to need.

The display unit 46 is configured to be able to display various screens generated under the control of the control unit 41. As the display unit 46, for example, various display devices such as an LCD (liquid crystal display) and an organic EL (electroluminescence) display can be used according to need.

The reading unit 47 is a device to acquire merchandise specifying information about a reading target merchandise item. In an example, the reading unit 47 may be an image pickup device (camera) to pick up and analyze an image of a symbol such as a barcode or a two-dimensional code attached to a merchandise item and thus specify the merchandise item, or perform package recognition to recognize the merchandise item based on the shape and external appearance of the merchandise in the picked-up image and thus specify the merchandise item, and thereby acquire merchandise specifying information that specifies the corresponding merchandise item. In an example, the reading unit 47 may be a wireless tag reading device to read tag information from a wireless tag such as an RFID tag attached to a merchandise item, using short-range wireless communication, and thus acquire merchandise specifying information that specifies the corresponding merchandise item. In an example, the reading unit 47 may be a scanner to optically read a symbol such as a barcode or a two-dimensional code attached to a merchandise item and thus acquire merchandise specifying information that specifies the corresponding merchandise item.

The reading unit 47 is a wireless tag reading device that reads tag information (identification information such as checkout card number) from the wireless tag 21 such as an RFID (radio frequency identification) tag attached to the checkout medium such as the checkout card 2, using short-range wireless communication. The reading unit 47 is also a wireless tag writing device that writes tag information (payment information) to the wireless tag 21 attached to the checkout medium such as the checkout card 2, using short-range wireless communication.

The image capture unit 48 is an image pickup device (camera) configured to be able to capture an image over an image capture area including at least the face of a customer purchasing a merchandise item in one transaction, on a per transaction basis, and thus acquire an image including at least the face of the customer. The image capture unit 48 is not an essential component and may be not provided in the registration machine 4. In such a case, an image from another camera such as a security camera installed in the store, instead of the image capture unit 48, may be used, and processing related to the image capture and discarding of the face image, described later, may be not performed.

The checkout machine 5 is at least one checkout device installed in the store. The checkout machine 5 is, for example, configured to be able to execute settlement processing of transaction processing related to one transaction for a merchandise item to be purchased at the store. The checkout machine 5 according to the embodiment is an example of a checkout unit.

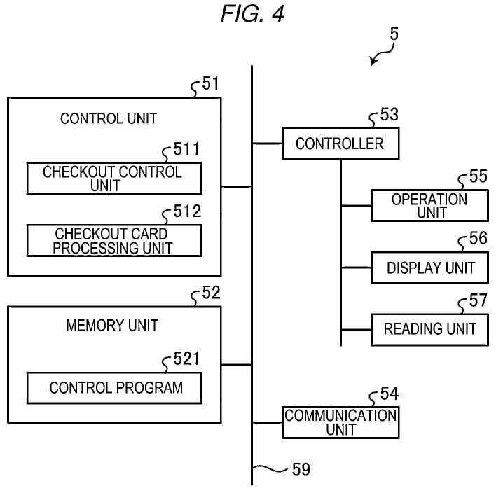

FIG. 4 is a block diagram showing an example of the configuration of the checkout machine 5 shown in FIG. 1. In an example, the number of checkout machines 5 is greater than the number of registration machines 4. FIG. 4 shows checkout machines 5-1, 5-2, 5-3 as the checkout machines 5. The number of checkout machines 5 may be one or may be two, three, or four or more. The number of checkout machines 5 need not necessarily be greater than the number of registration machines 4. The checkout machine 5 has a control unit 51, a memory unit 52, a controller 53, a communication unit 54, an operation unit 55, a display unit 56, and a reading unit 57, as shown in FIG. 4. The control unit 51, the memory unit 52, the controller 53, and the communication unit 54 are communicably connected, for example, via a bus 59. The operation unit 55, the display unit 56, and the reading unit 57 are communicably connected to the controller 53.

The control unit 51 has, for example, a processor such as a CPU, and a memory such as a ROM and a RAM, and is configured similarly to a general computer. For example, the control unit 51 is configured to load various programs stored in the memory such as the ROM or the memory unit 52 into the RAM of the memory, cause the processor to execute the various programs thus loaded, and thereby implement various: functions of the checkout machine 5 including a checkout control unit 511 and a checkout card processing unit 512.

The checkout control unit 511 reads payment information from the wireless tag 21 in the checkout card 2 and carries out settlement for a merchandise item registered at the registration machine 4. That is, the checkout control unit 511 performs settlement processing for one transaction, based on the payment information read by the checkout card processing unit 512, that is, without performing communication such as sending an information request to the store server 3 or the registration machine 4. The checkout control unit 511 also transmits a notification of the completion of the settlement including the checkout card number (identification information) of the checkout card 2 with which the settlement processing is performed, the merchandise information of the merchandise item for which the settlement is complete (item for which the payment is complete), and settlement information (that is, sales information), to the store server 3. The settlement information may be not transmitted in view of reduction in the communication volume. If the settlement is complete for all the merchandise items, notification information to the effect the settlement is complete for all the merchandise items may be transmitted instead of the merchandise information of the item for which the payment is complete. Alternatively, if the settlement is complete for all the merchandise items, only the checkout card number (identification information) of the checkout card 2 with which the settlement processing is carried out may be transmitted, and in response to this, the registration machine 4 may recognize that the settlement is complete for all the merchandise items. If the settlement is complete for all the merchandise items, the store server 3 discards the temporarily stored face image in response to the notification of the completion of the settlement. That is, if the settlement is complete for all the merchandise items, the checkout control unit 511 transmits the notification of the completion of the settlement to the store server 3 and thus discards (deletes) the face image of the customer.

The checkout card processing unit 512 controls the reading unit 57 and thus acquires the checkout card number (identification information) and the payment information from the checkout card 2 (checkout medium) held over or inserted in the reading unit 57, for example, by the customer. Also, the checkout card processing unit 512 controls the reading unit 57, thus rewrites the payment information on the checkout card 2, and erases the payment information of the merchandise item for which the settlement is complete (item for which the payment is complete). That is, the checkout card processing unit 512 controls the reading unit 57 and thus deletes the payment information about the transaction in which the settlement is complete for all the merchandise items the merchandise registration of which is already done. In other words, if the settlement is complete, the checkout card processing unit 512 rewrites the payment information on the checkout card 2 to represent the state where there is no unpaid amount.

As the processor of the control unit 51 according to the embodiment, various processors such as a GPU and a DSP, and a dedicated computing circuit implemented by an ASIC or an FPGA, or the like, can be used according to need, instead of or in addition to the CPU.

The memory unit 52 is a memory device having a non-volatile recording medium such as an HDD, an SSD or a flash memory. The memory unit 52 stores various programs and various data related to operations of the checkout machine 5, and a device driver for a device connected to the checkout machine 5 via the controller 53, or the like.

In an example, the memory unit 52 stores a control program 521. For example, the control program 521 includes at least one program to implement each functional unit of the checkout machine 5. The memory unit 52 may store a merchandise master.

The controller 53 is an input-output interface to connect a device to the checkout machine 5. In the example shown in FIG. 4, the operation unit 55, the display unit 56, and the reading unit 57 are connected to the controller 53.

The communication unit 54 is a communication interface to communicate with the outside of the checkout machine 5. The communication unit 54 includes one of a communication circuit for wired communication and a communication circuit for wireless communication and connects to the communication network via the communication circuit.

The operation unit 55 is an input interface that accepts an operation input from a user such as a customer. The operation unit 55 is, for example, a touch panel that is arranged on a display surface (screen) of the display unit 56 and that detects a touch operation by an operator and outputs a signal to the control unit 51. In an example, the operation unit 55 is configured to be able to accept an operation input from the operator to an operation screen displayed on the display unit 56. As the operation unit 55, not only the touch panel but also various input devices such as a keyboard, a switch, and a button can be provided according to need.

The display unit 56 is configured to be able to display various screens generated under the control of the control unit 51. As the display unit 56, for example, various display devices such as a liquid crystal display and an organic EL display can be used according to need.

The reading unit 57 is a wireless tag reading device that reads tag information from the wireless tag 21 such as an RFID tag attached to the checkout card 2, using short-range wireless communication, and thus acquires necessary information for settlement processing. The necessary information for settlement processing is information that includes the identification information (checkout card number) of the checkout card 2 and the payment information and that is sufficient for the completion of settlement processing. The reading unit 57 is also a wireless tag writing device that writes or deletes tag information (payment information) to or from the wireless tag 21 attached to the checkout medium such as the checkout card 2, using short-range wireless communication.

The exit gate 6 is a gate device provided between the checkout machine 5 and the entrance and exit of the store, on a movement route on which a customer moves from inside the store to outside the store. The exit gate 6 according to the embodiment is an example of a reporting unit.

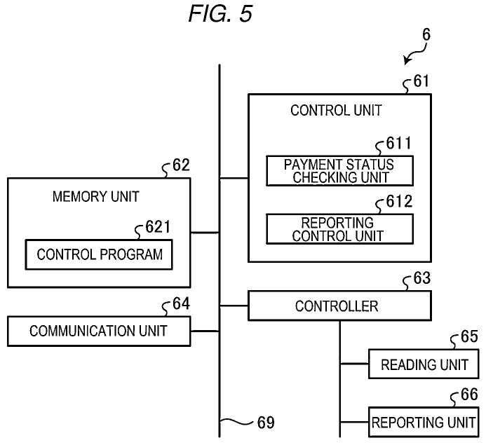

FIG. 5 is a block diagram showing an example of the configuration of the exit gate 6 shown in FIG. 1. The exit gate 6 has a control unit 61, a memory unit 62, a controller 63, a communication unit 64, a reading unit 65, and a reporting unit 66, as shown in FIG. 5. The control unit 61, the memory unit 62, the controller 63, and the communication unit 64 are communicably connected, for example, via a bus 69. The reading unit 65 and the reporting unit 66 are communicably connected to the controller 63.

The control unit 61 has, for example, a processor such as a CPU, and a memory such as a ROM and a RAM, and is configured similarly to a general computer. For example, the control unit 61 is configured to load various programs stored in the memory such as the ROM or the memory unit 62 into the RAM of the memory, cause the processor to execute the various programs thus loaded, and thereby implement various functions of the exit gate 6 including a payment status checking unit 611 and a reporting control unit 612.

The payment status checking unit 611 controls the reading unit 65 and thus acquires the checkout card number (identification information) and the payment information from the checkout card 2 (checkout medium) held by, for example, the customer passing through the exit gate 6. The payment status checking unit 611 also checks whether it is the state where there is no unpaid amount (the payment is complete), based on the payment information thus read, that is, whether there is payment information about a merchandise item for which the settlement is not complete.

The reporting control unit 612 controls the reporting unit 66 and thus performs reporting processing to give a report, for example, if the checkout card 2 held by the customer passing through the exit gate 6 is in the state where there is an unpaid amount. In other words, the reporting control unit 612 give a report if the payment information in the wireless tag 21 represents the state where there is an unpaid amount when the checkout card 2 passes therethrough. This reporting may be giving an alert by the reporting unit 66. Giving the alert may be outputting a warning sound or a voice, turning on an indicator lamp in a warning color (for example, red), turning on a dedicated warning lamp, reporting to a portable terminal or the like carried by store staff, security staff, or monitoring staff, or a combination of these measures. In the reporting processing, if the checkout card 2 is in the state where there is no unpaid amount (the payment is complete), the reporting control unit 612 may not perform the processing or may turn on, for example, the indicator lamp in a normal color (for example, blue) to report that it is the state where there is no unpaid amount. Also, in the reporting processing, the reporting control unit 612 may notify the store server 3 of the checkout card number of the checkout card 2 in the state where there is an unpaid amount, or may notify the store server 3 of the result of checking the payment status about each checkout card number that is read.

Also, a configuration in which the customer performs settlement processing after exiting the store, for the payment information about an unpaid amount, for example, using a member app (application program) installed in a portable terminal such as a smartphone, can be employed. Therefore, the reporting at the exit gate 6 is not limited to the warning and may be notifying the customer side and/or the store side if the payment is complete or not.

Also, in the reporting processing, if the checkout card 2 is not read even though the customer passes through the exit gate 6, the reporting control unit 612 may notify the customer side and/or the store side.

As the processor of the control unit 61 according to the embodiment, various processors such as a GPU and a DSP, and a dedicated computing circuit implemented by an ASIC or an FPGA, or the like, can be used according to need, instead of or in addition to the CPU.

The memory unit 62 is a memory device having a non-volatile recording medium such as an HDD, an SSD or a flash memory. The memory unit 62 stores various programs and various data related to operations of the exit gate 6, and a device driver for a device connected to the exit gate 6 via the controller 63, or the like.

In an example, the memory unit 62 stores a control program 621. For example, the control program 621 includes at least one program to implement each functional unit of the exit gate 6.

The controller 63 is an input-output interface to connect a device to the exit gate 6. In the example shown in FIG. 5, the reading unit 65 and the reporting unit 66 are connected to the controller 63.

The communication unit 64 is a communication interface to communicate with the outside of the exit gate 6. The communication unit 64 includes one of a communication circuit for wired communication and a communication circuit for wireless communication and connects to the communication network via the communication circuit.

The reading unit 65 is a wireless tag reading device that reads tag information from the wireless tag 21 such as an RFID tag attached to the checkout card 2, using short-range wireless communication, and thus acquires necessary information for payment status checking processing. The necessary information for payment status checking processing is information that includes the identification information (checkout card number) of the checkout card 2 and the payment information and that is sufficient for the determination about whether there is payment information about an unpaid amount.

The reporting unit 66 may be a speaker that outputs a warning sound or a voice, an indicator lamp, or a combination of these measures. The indicator lamp may turn on in a warning color (for example, red) to give a report if there is payment information about an unpaid amount. The indicator lamp may also turn on in normal color (for example, blue) if it is the state where there is no unpaid amount (the payment is complete). The indicator lamp may also give a report by flashing on and off or by turning on.

An example of operations of the merchandise checkout system 1 with the above configuration will now be described with reference to the drawings.

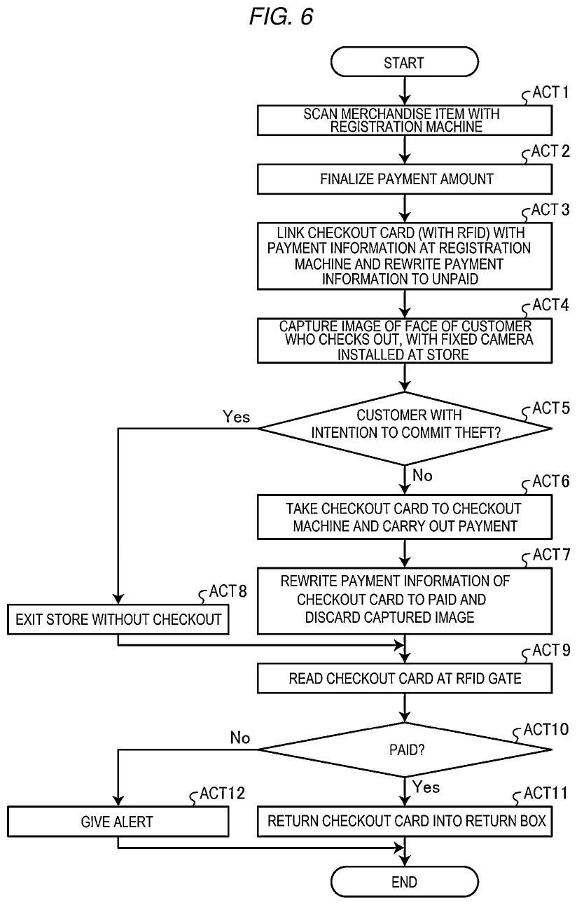

FIG. 6 is a flowchart showing an example of the flow of one transaction in the merchandise checkout system 1 according to the embodiment. The flow shown in FIG. 6 is simply an example. An addition or deletion of a process and a change in the order of processes can be made according to need.

First, the store staff operates the registration machine 4 and performs merchandise registration processing to register at least one merchandise item to be purchased by the customer (ACT 1). The registration machine 4 then finalizes the payment amount for the merchandise item the merchandise registration of which is already done, with reference to the merchandise master 422, and finalizes the payment information about the transaction (ACT 2).

The store staff causes the registration machine 4 to recognize the checkout card 2, links the identification information of the checkout card 2 with the finalized payment information, writes the finalized payment information to the checkout card 2, and dispenses the checkout card 2 (ACT 3). In this case, the checkout card 2 is in the state where there is an unpaid amount. The store staff hands over the dispensed checkout card 2 to the customer. The registration machine 4 also captures an image including the face of the customer in this one transaction (ACT 4). After that, the registration machine 4 transmits the payment information and the image each of which is linked with the identification information of the checkout card 2, that is, the checkout information, to the store server 3.

If the customer does not have an intention to commit a theft (NO in ACT 5), the customer moves to any checkout machine 5, taking the checkout card 2 handed over by the store staff. The customer causes any checkout machine 5 to read the checkout card 2 and thus performs settlement processing (ACT 6). The checkout machine 5 rewrites and erases the payment information on the checkout card 2 about the merchandise item for which the settlement is complete (item for which the checkout is complete). That is, if the settlement processing is complete, the checkout machine 5 rewrites the checkout card 2 into the state where there is no unpaid amount (the payment is complete). The checkout machine 5 also notifies the store server 3 of the completion of the settlement. The notification of the completion of the settlement includes, for example, the identification information (for example, checkout card number) of the checkout card 2. The store server 3 changes the checkout information 323 to represent that the checkout is complete, in response to the notification of the completion of the settlement from the checkout machine 5. In view of privacy protection, the store server 3 discards the face image of the customer in the checkout information 323 linked with the checkout card 2 with which the checkout is complete (ACT 7).

If the customer has an intention to commit a theft (YES in ACT 5), the customer moves toward the exit of the store without making a payment at the checkout machine 5, trying to exit the store in the state where the checkout is yet to be done for at least one merchandise item (ACT 8). In this case, the payment information on the checkout card 2 is not rewritten for all the merchandise items the merchandise registration of which is already done. The payment information still represents the state where there is an unpaid amount.

After that, the exit gate 6 for security provided at the exit of the store reads the checkout card 2 held by the customer passing therethrough (ACT 9).

If the checkout card 2 is in the state where there is no unpaid amount (YES in ACT 10), the exit gate 6 may not perform any particular processing. Alternatively, the exit gate 6 may turn on, for example, the indicator lamp in a normal color (for example, blue) to report that it is the state where there is no unpaid amount. The customer, after passing through the exit gate 6, returns the checkout card 2 held by the customer into a return box installed on the store exit side of the exit gate 6, that is, a place beyond the exit gate 6 (ACT 11). The return box for checkout may be in any form that can recover the checkout card 2 returned from the customer, and may be a simple box or may have such a structure that the customer cannot take out the checkout card 2 after putting the checkout card 2 therein, for example, like an offertory box.

Meanwhile, if the checkout card 2 is in the state where there is an unpaid amount (NO in ACT 10), the exit gate 6 gives an alert (ACT 12).

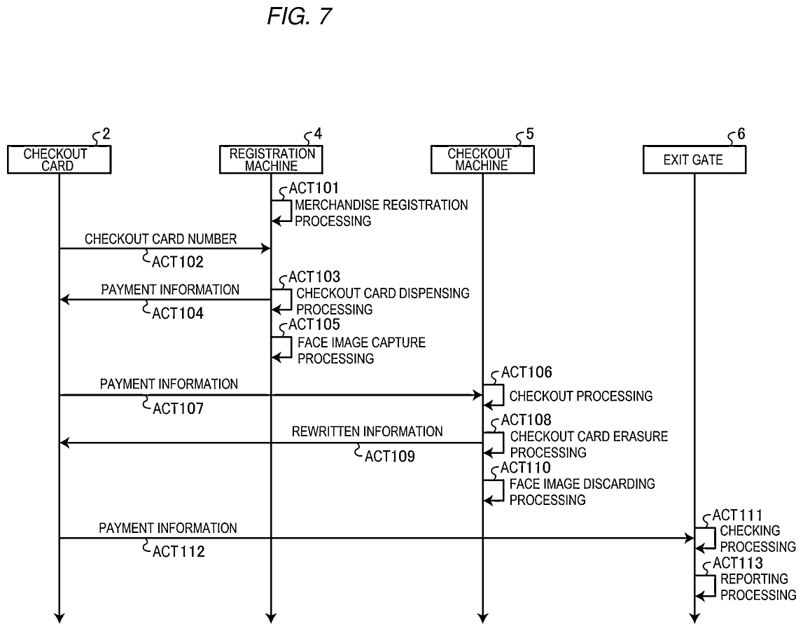

FIG. 7 is a sequence chart showing an example of the flow of processing related to one transaction executed by the merchandise checkout system 1 according to the embodiment. The flow of processing shown in FIG. 7 is simply an example. An addition or deletion of a process and a change in the order of processes can be made according to need.

The registration machine 4 performs registration processing for a merchandise item in one transaction and finalizes the payment information (ACT 101). The registration machine 4 acquires the checkout card number (identification information) of the checkout card 2 (checkout medium) held over or inserted in the reading unit 47, for example, by store staff, and recognizes the checkout card 2 (ACT 102).

The registration machine 4 performs dispensing processing for the recognized checkout card 2 (ACT 103). In the dispensing processing for the checkout card 2, the registration machine 4 writes the payment information about the one transaction to the checkout card 2 (ACT 104). The registration machine 4 also performs face image acquisition processing to capture an image of the face of the customer corresponding to the one transaction and thus acquire a face image (ACT 105). The registration machine 4 then links the payment information and the face image corresponding to the one transaction with the checkout card number of the checkout card 2 and thus transmits the payment information and the face image to the store server 3. The registration machine 4 may transmit the payment information and the face image separately from each other to the store server 3.

The checkout machine 5 performs checkout processing with the checkout card 2 (checkout medium) held over or inserted in the reading unit 57, for example, by the customer (ACT 106). In this processing, the checkout machine 5 acquires the checkout card number (identification information) and the payment information from the checkout card 2 (ACT 107). The checkout machine 5 then performs settlement processing for the merchandise item in the one transaction, based on the payment information read from the checkout card 2, that is, without sending an inquiry to the store server 3 or the registration machine 4.

The checkout machine 5 also performs erasure processing on the checkout card 2 with respect to the merchandise item for which the settlement is complete (ACT 108). In the erasure processing, the checkout machine 5 rewrites the payment information on the checkout card 2 and erases the payment information of the merchandise item for which the settlement is complete (item for which the payment is complete). That is, the payment information about the transaction in which the settlement is complete for all the merchandise items the merchandise registration of which is already done is deleted from the checkout card 2.

The checkout machine 5 performs discarding processing of the face image of the customer with respect to the transaction in which the settlement is complete for all the merchandise items the merchandise registration of which is already done (ACT 110). In the discarding processing of the face image, the checkout machine 5 transmits a notification of the completion of the settlement including the checkout card number (identification information) of the checkout card 2 with which the settlement processing is performed, to the store server 3. The store server 3 deletes the face image from the checkout information 323 in response to the notification from the checkout machine 5. That is, the checkout machine 5 transmits the notification of the completion of the settlement to the store server 3 and thus discards the face image corresponding to the one transaction.

The exit gate 6 performs checking processing of the payment status (ACT 111). In the checking processing, the exit gate 6 reads the payment information from the checkout card 2 passing therethrough (ACT 112). The exit gate 6 also checks whether the checkout card 2 passing therethrough is in the state where there is no unpaid amount (the payment is complete). The exit gate 6 performs reporting processing, based on the checking processing of the payment status (ACT 113). For example, the exit gate 6 gives a report if it is the state where there is an unpaid amount.

In this way, the merchandise checkout system 1 according to the embodiment is a semi-self-service-type checkout system and is configured to dispense the checkout card 2 storing payment information based on registration processing and perform settlement processing based on the payment information.

With this configuration, necessary data for the settlement processing is recorded on the checkout card 2 and therefore the settlement processing with the checkout card 2 as the starting point and based on the information stored on the checkout card 2 can be implemented. Thus, the trouble taken by the store staff on the registration machine 4 side to designate which checkout machine 5 the customer should use for the checkout can be reduced. Also, since the customer can use any checkout machine 5 such as an unoccupied checkout machine 5, a situation where it is difficult for the customer to grasp which checkout machine 5 to use to perform the settlement (checkout) processing, as in the case where it is difficult to find the checkout machine 5 designated by the store staff, or the like, or a situation where it takes some time to reach the designated checkout machine 5, can be eliminated. Therefore, with the above configuration, the risk of congestion on the checkout machine side can be reduced and an improvement in the efficiency of transaction can be achieved. Thus, the number of checkout machines 5 per registration machine 4 can be reduced.

In a store such as a supermarket, a checkout needs to be carried out for a first-time customer, unlike in a system employed by a hospital or the like where a checkout can be carried out using a patient registration card linked with an individual. In circumstances, such with the above configuration, the payment information is stored on the checkout card 2 and therefore the settlement processing based on the information stored on the checkout card 2 can be implemented even in a checkout for a first-time customer.

Since the payment information is stored on the checkout card 2, an inquiry from the checkout machine 5 to the store server 3 or the registration machine 4 in the settlement processing can be eliminated. Therefore, a checkout similar to a related-art semi-self-service-type checkout can be implemented even in an offline environment, and the volume of data communication of the checkout machine 5 can be reduced by employing unidirectional communication from the checkout machine 5 to the master (store server 3). The reduction in the volume of data communication of the checkout machine 5 reduces the load on the master side and is also useful for the provision of wireless communication between the checkout machine 5 and the outside.

Since the payment information is stored on the checkout card 2, the store side can grasp the payment information about an unsettled transaction even if the checkout card 2 is found at a later date, that is, if the information about the transaction is eliminated from the master of the store server 3.

Since the payment information is stored on the checkout card 2, even if an illegal act such as a theft (where there is an unpaid amount) is conducted or even if the checkout card 2 is found at a later date and no information is left in the store server 3, what was stolen can be grasped.

The checkout card 2 is a card-like checkout medium with a built-in wireless tag 21 and is relatively inexpensive. Therefore, even if the checkout card 2 cannot be recovered as in the case where the customer does not return the checkout card 2 into the return box and takes the checkout card 2 home instead, the loss on the store side is small.

Since a configuration where a report is given at the exit gate 6 based on the payment information on the checkout card 2 is employed, the store staff, security staff or monitoring staff may have to monitor only a clearly abnormal action of the customer such as going home, leaving only the checkout card 2 in the store. Therefore, the trouble taken to monitor illegal acts can be reduced.

In the foregoing embodiment, the case where a report is given based on whether the payment information represents that there is an item (merchandise item) for which the checkout is yet to be carried out, is described. However, this is not limiting. The checkout card 2 may store flag information representing whether there is a merchandise item for which the checkout is yet to be carried out, and a report may be given at the exit gate 6, based on the flag information.

If a door is provided at the exit gate 6, the door may be configured to open in response to the return of the checkout card 2 or the payment status thereon.

At least one embodiment described above can achieve an improvement in the efficiency of transaction in a semi-self-service-type checkout system.

In the foregoing embodiment, to “determine whether it is A” may be to “determine that it is A”, to “determine that it is not A”, or to “determine whether it is A or not”.

Each control program executed by each device in the merchandise checkout system 1 according to the embodiment may be provided in the state of being incorporated in advance in a recording medium such as a ROM.

Each control program executed by each device in the merchandise checkout system 1 according to the embodiment may be configured to be provided in the state of being recorded as a file in an installable format or an executable format on a computer-readable recording medium such as a CD-ROM, a FD (flexible disk), a CD-R, or a DVD (digital versatile disk).

Each control program executed by each device in the merchandise checkout system 1 according to the embodiment may be configured to be stored on a computer connected to a network such as the internet, then downloaded via the network, and thus provided. Each control program executed by each device in the merchandise checkout system 1 according to the embodiment may also be configured to be provided or distributed via a network such as the internet.

For example, the control program 321 executed by the store server 3 according to the embodiment has a module configuration including the foregoing unit (management unit 311). The processor of the control unit 31 reads the control program 321 from the recording medium and loads the foregoing unit onto the main memory device such as the RAM of the control unit 31. Thus, the foregoing unit is generated on the main memory device.

For example, the control program 421 executed by the registration machine 4 according to the embodiment has a module configuration including the foregoing units (registration control unit 411, checkout card dispensing unit 412, and image capture control unit 413). The processor of the control unit 41 reads the control program 421 from the recording medium and loads the foregoing units onto the main memory device such as the RAM of the control unit 41. Thus, the foregoing units are generated on the main memory device.

For example, the control program 521 executed by the checkout machine 5 according to the embodiment has a module configuration including the foregoing units (checkout control unit 511 and checkout card processing unit 512). The processor of the control unit 51 reads the control program 521 from the recording medium and loads the foregoing units onto the main memory device such as the RAM of the control unit 51. Thus, the foregoing units are generated on the main memory device.

For example, the control program 621 executed by the exit gate 6 according to the embodiment has a module configuration including the foregoing units (payment status checking unit 611 and reporting control unit 612). The processor of the control unit 61 reads the control program 621 from the recording medium and loads the foregoing units onto the main memory device such as the RAM of the control unit 61. Thus, the foregoing units are generated on the main memory device.

While some embodiments of the present disclosure have been described, these embodiments are presented simply as examples and are not intended to limit the scope of the present disclosure. These novel embodiments can be implemented in various other forms and can include various omissions, replacements, and changes without departing from the spirit and scope of the present disclosure. These embodiments and modifications thereof are included in the spirit and scope of the present disclosure and also included in the scope of the claims and equivalents thereof.

What is claimed is:

1. A merchandise checkout system, comprising:
a checkout medium with a built-in wireless tag;
a registration component configured to register a merchandise item in one transaction and dispense the checkout medium where payment information for settlement for the merchandise item in the one transaction that is registered is written in the wireless tag;
a checkout component configured to read the payment information from the wireless tag in the checkout medium, carry out settlement for the merchandise item in the one transaction that is registered, and rewrite the payment information to represent a first state where there is no unpaid amount if the settlement is complete; and
a reporting component configured to give a report if the payment information in the wireless tag represents a second state where there is an unpaid amount when the checkout medium passes therethrough.

2. The merchandise checkout system according to claim 1, further comprising:
an image capture component configured to be able to capture an image over an image capture area including at least a face of a customer purchasing the merchandise item in the one transaction; and
a management component configured to link and store the payment information and a face image capture by the image capture component, with identification information of the checkout medium.

3. The merchandise checkout system according to claim 2, wherein
if the settlement for the merchandise item in the one transaction that is registered is complete, the checkout component notifies the management component of the completion of the settlement, and
the management component discards the face image in response to the notification of the completion of the settlement from the checkout component.

4. The merchandise checkout system according to claim 1, wherein
the registration component, before writing the payment information, gives a report if payment information representing the second state where there is an unpaid amount is recorded on the wireless tag in the checkout medium.

5. The merchandise checkout system according to claim 1, wherein
the checkout medium comprises one of a flat plate-like checkout card with a built-in wireless tag, a keychain with a built-in wireless tag, a neck strap with a built-in wireless tag, a shopping basket with a built-in wireless tag, or a shopping cart with a built-in wireless tag.

6. The merchandise checkout system according to claim 1, wherein
the merchandise checkout system is a point of sales system.

7. The merchandise checkout system according to claim 1, wherein
the checkout component comprises a wireless tag reading device that reads tag information from the wireless tag.

8. The merchandise checkout system according to claim 1, wherein
the report of payment information representing the second state is executed via one or more of a screen display, an indicator lamp, and a speaker.

9. A merchandise registration device, comprising:
a registration component configured to register a merchandise item in one transaction; and
a dispensing component configured to write payment information onto a wireless tag built in a checkout medium and dispense the checkout medium, the payment information comprising information for settlement for the merchandise item in the one transaction that is registered, the payment information including merchandise information, a unit price, and a number of items, about each of at least one merchandise item on which merchandise registration is already done, and a total payment amount.

10. The merchandise registration device according to claim 9, wherein
the dispensing component controls a reading component to dispense the checkout medium.

11. The merchandise registration device according to claim 9, wherein
the dispensing component links the payment information written on the checkout medium with a checkout medium number.

12. The merchandise registration device according to claim 11, wherein
the dispensing component transmits the payment information to a management component.

13. The merchandise registration device according to claim 9, wherein
the checkout medium comprises one of a flat plate-like checkout card with a built-in wireless tag, a keychain with a built-in wireless tag, a neck strap with a built-in wireless tag, a shopping basket with a built-in wireless tag, or a shopping cart with a built-in wireless tag.

14. The merchandise registration device according to claim 9, wherein
the merchandise registration device is a point of sales terminal.

15. A merchandise registration method, comprising:
registering a merchandise item in one transaction; and
writing payment information onto a wireless tag built in a checkout medium and dispensing the checkout medium, the payment information comprising information for settlement for the merchandise item in the one transaction that is registered, the payment information including merchandise information, a unit price, and a number of items, about each of at least one merchandise item on which merchandise registration is already done, and a total payment amount.

16. The merchandise registration method according to claim 15, further comprising:
controlling a reading component to dispense the checkout medium.

17. The merchandise registration method according to claim 15, further comprising:
linking the payment information written on the checkout medium with a checkout medium number.

18. The merchandise registration method according to claim 17, further comprising:
transmitting the payment information to a management component.

19. The merchandise registration method according to claim 15, wherein
the checkout medium comprises one of a flat plate-like checkout card with a built-in wireless tag, a keychain with a built-in wireless tag, a neck strap with a built-in wireless tag, a shopping basket with a built-in wireless tag, or a shopping cart with a built-in wireless tag.
